(19) United States
(12) Patent Application Publication
(10) Pub. No.: US 2002/0056677 A1
(43) Pub. Date: May 16, 2002

(54) Device for filtering and adding grain refining agent to metal melts

(76) Inventors: Wolfgang Schneider, St. Augustin (DE); Hans-Peter Krug, Rheinbach-Flerzheim (DE); Nick Towsey, Bonn (DE)

Correspondence Address: FISH & NEAVE, 1251 AVENUE OF THE AMERICAS, 50TH FLOOR, NEW YORK, NY, 10020-1105, US

(21) Appl. No.: 09/986,446

(22) Filed: Nov. 8, 2001

(30) Foreign Application Priority Data
Nov. 9, 2000 (DE) 10055523.3

(51) Int. Cl. B01D 39/20

(52) U.S. Cl. 210/201; 210/510.1

(57) ABSTRACT

The invention relates to a device for filtering and adding grain refining materials to metal melts with a first filter (10) and a feed for a grain-refining material, where the first filter has a porous filter medium. The filter efficiency of the first filter (10) is substantially improved according to the invention by arranging the feed for the grain-refining material in the direction of flow after the first filter (10). The undissolved impurities introduced via the grain-refining material are removed by positioning a second filter (16) in the direction of flow after the feed for the grain-refining material.

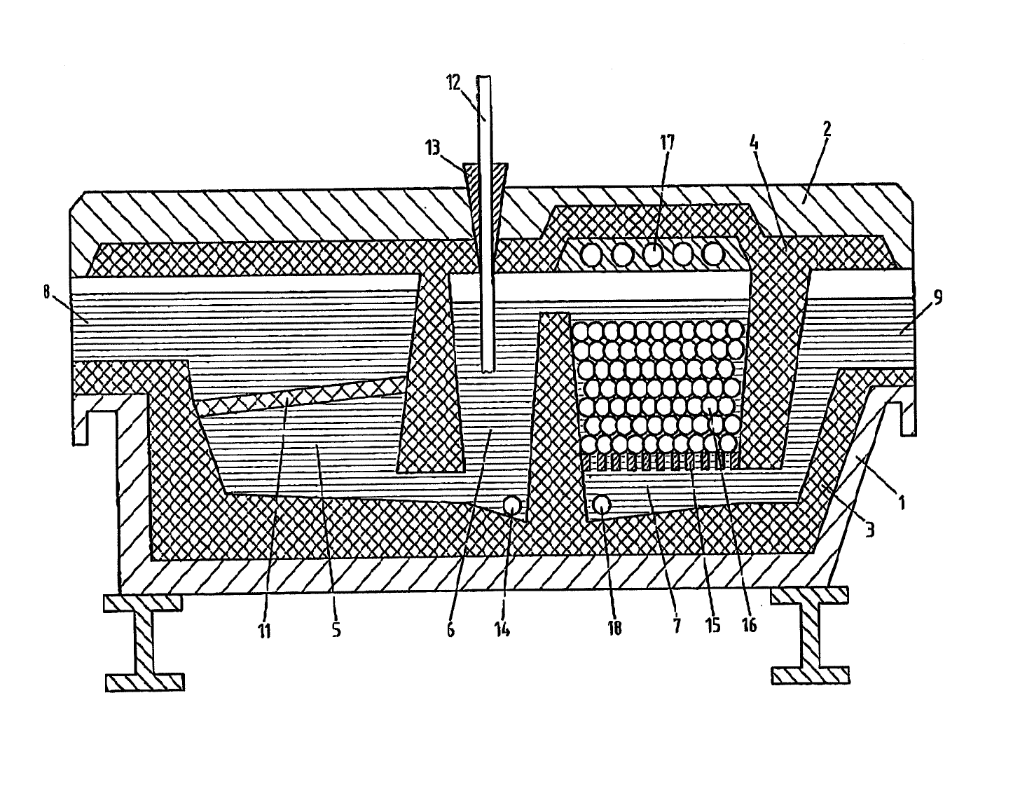

The invention relates to a device for filtering and adding grain refining materials to metal melts with a first filter and a feed for a grain-refining material, where the first filter has a porous filter medium.

It is known from the prior art that metal melts, e.g. melts of aluminium alloys can be filtered during the casting process. As an example of this, reference is subsequently made the casting of aluminium alloys. However, the filtering of metal melts is also known, for example, for copper and steel alloys. During the casting of aluminium the metal melt flows out of the casting furnace via an inline degasser and a device for filtering and adding grain-refining materials to the casting mould. The inline degasser removes in an inherently known fashion essentially dissolved gaseous impurities from the aluminium melt. This predominantly involves dissolved hydrogen. After dissolved impurities have bear removed or reduced, a grain refining material, for example aluminium-titanium-boron master alloys, is supplied to the aluminium melt according to the prior art. After this grain refining material has been supplied, resulting in smaller grain sizes in the solidified material during the subsequent casting, according to the prior art the aluminium melt is filtered to remove undissolved impurities, i.e. solid particles not dissolved in the melt. These undissolved impurities comprise, for example, aluminium oxide particles, aluminium carbides, aluminium carbonitrides etc. These undissolved impurities have sizes of around 1 to 100 μm. Following the filtration process, the aluminium melt then flows to the casting mould, as mentioned previously, and is these cast into ingots, for example.

According to the prior art the melt is filtered after adding the grain-refining materials since the grain-refining materials also carry undissolved impurities into the melt. For example, the aluminium titanium boron master alloy used as grain refining material contains large insoluble titanium diboride particles and oxide inclusions which are undesirable in the subsequent cast product.

Various types of filters are known for filtering aluminium melts. Especially reasonably priced and space-saving filtration can be achieved by using so-called ceramic foam filters. These ceramic foam filters are used in plate form, approximately 50 mm thick, and the aluminium melts flows through perpendicular to the plane of the plate. These ceramic foam filters are manufactured by impregnating an open-pore polyurethane foam with a water-based aluminium oxide sludge and binders. This impregnated polyurethane foam is then dried and baked whereby the polyurethane foam is burnt away and a negative image of the foam structure is left as ceramic foam. The filter efficiency of ceramic foam filters when used according to the prior art is moderate to good.

Another known filter system for aluminium melts are the so-called loose-fill bed filters. In a loose-fill bed filter the filter medium through which the aluminium melt is passed consists of aluminium oxide granules or beads as a partly layered fill in a filter box. If loose-fill bed filters are used exclusively for filtering, this requires large filter boxes which however have a significantly longer service life compared with using ceramic foam filters. The filter efficiency of loose-fill bed filters can be described as consistently good.

The simple filter systems known from the prior art, such as for example ceramic foam filters are distinguished by lower costs and a lower space requirement compared with more expensive filter systems, such as loose-fill bed filters for example. At the same time, the expensive systems known from the prior art exhibit a higher filter efficiency ad longer service lives.

On the basis of the prior art described previously the problem for the present invention is to propose a device for filtering and adding grain-refining materials to metal melts which makes it possible to achieve a high filter efficiency with simple filter systems.

According to the invention, the problem derived and indicated previously is solved by providing the feed for the grain-refining material in the direction of flow after the first filter and providing a second filter in the direction of flow after the feed for the grain-refining material. Surprisingly it has been found that for metal melts the filter properties of a filter having a porous filter medium are so significantly influenced by the previous addition of grain-refining materials towards lower filter efficiencies that the better filter efficiency of the first filter can even justify adding grain-refining material with the undissolved impurities contained therein after the first filter. In order to remove the undissolved impurities, carried into the melt via the grain-refining material, a second filter is provided in the direction of flow after the feed for the grain-refining material.

Tests have shown that with respect to their filter efficiency especially filters based on filtration by means of cake formation, react sensitively to the addition of grain-refining material. If these filters are used after the addition of grain-refining material, cake formation is impeded or even prevented whereby these filters do not attain their full filter action. The filter efficiency of this filter is significantly improved by the arrangement of the first filter based on cake filtration before the feed for the grain-refining material according to the invention.

In a ceramic foam filter without grain-refining material being added before the filter, bridges are formed consisting of an accumulation of undissolved impurities. These bridges bring about a significant improvement in the filter efficiency of the ceramic foam filter. This bridge formation cannot be observed when grain-refining material is added before the ceramic foam filter. Accordingly the first filter of the device according to the invention preferably has a plate made of ceramic foam.

It has been found that the bridges of undissolved impurities which improve the filter efficiency do not form over the entire 50 mm thickness of the ceramic foam plates normally used. With regard to the flow resistance in a device according to the invention the ceramic foam plate therefore has a thickness of 5 to 30 mm, preferably 10 to 15 mm.

Alternatively or cumulatively to a ceramic foam plate, the first filter advantageously has at least one element of sintered material and/or an element consisting of material deposited by CVD (Chemical Vapour Deposition).

Porous media are preferably suitable for filtering solid undissolved impurities. Accordingly the device according to the invention in thereby preferably arranged so that the second filter has a porous filter medium.

As a result of the relatively low load of undissolved impurities, a deep-bed filter is especially suitable for filtering the undissolved impurities introduced into the metal melt by the grain-refining material after the first filter. In view of the low impurity load, this deep bed filter can have considerably smaller dimensions than those normally required when deep-bed filters alone are used for filtration.

A particularly suitable deep-bed filter for filtering metal melts is the so-called loose-fill bed filter. In a loose-fill bed filter the porous material is formed by a filling of generally compact filter beads and/or filter granules.

According to another refinement, the first filter and/or the second filter of the device according to the invention can be heated. The allows multiple usage of the first and/or second filters for successive batches.

In addition to the device, the invention also relates to a method for filtering and adding grain-refining materials to metal melts where the melt is filtered with the aid of a first filter having a porous filter medium and a grain-refining material is supplied to the melt. A method of this type known from the prior art is improved on the basis of the problem according to the invention indicated above by supplying the grain-refining material to the melt after the first filter and filtering the melt in the direction of flow after the feed for the grain-refining material with the aid of a second filter.

There are now a plurality of possibilities for configuring and further developing the device according to the invention or the method according to the invention for filtering and adding grain-refining material to metal melts. For this purpose reference is made on the one hand, for example, to the claims assigned to claim 1 and on the other hand, to the description of an example of embodiment in connection with the drawings.

The only FIGURE in the drawings shows a schematic cross-section of an example of embodiment of a device according to the invention for filtering and adding grain-refining materials to metal melts.

The example of embodiment of a device according to the invention shown in the only FIGURE has a lower outer frame 1 and an upper outer frame 2. In the lower outer frame 1 are the regions through which an aluminium melt flows in the present example of embodiment, defined by a thermally resistant outer lining 3 which interacts with a thermally resistant upper lining 4 of the upper outer frame 2.

In the example of embodiment shown in the only FIGURE the aluminium melt is shown by the horizontal shading. The lower lining 3 and the upper lining 4 define in their interaction a first filter chamber 5, an addition chamber 6 for the grain-refining material and a second filter chamber 7 as well as an inlet region 8 and an outlet region 9.

In the first filter chamber 5 a ceramic foam plate 11 is provided as the first filter. The plate 11 is arranged at a small angle to the horizontal to allow the removal of gas inclusions.

In the addition chamber a wire 12 consisting of a grain-refining material is supplied by a feed not shown in detail through a feed opening 13 at a defined speed. The wire 12 melts in the aluminium melt whereby the grain-refining materials goes into solution in a defined concentration.

The first filter chamber 5 and the addition chamber 6 are provided with a common first drain 14 which makes it possible to empty the first filter chamber 5 and the addition chamber 6 after filtering a charge. Usually, according to the prior art the ceramic foam place 11 is exchanged after filtering each batch. This is not absolutely necessary when a ceramic foam filter is used in a device according to the invention. Consequently the first filter chamber 5 can be heated jointly with the addition chamber 6 so that the same ceramic foam plate 11 can be used for several batches. In this case the first filter chamber 5 and the addition chamber 6 are not emptied after filtering a batch. In the second filter chamber 7 there is provided on a grid 15 a loose-fill bed filter 16 consisting of a plurality of aluminium oxide beads. The second filter chamber 7 can be heated via heating 17 whereby emptying of the second filter chamber 7 between two batches is dispensed with. In order to make it possible to change the loose-fill bed filter 16, the second filter chamber 7 also has a second drain 10. As an alternative to the heating 17 shown in the only FIGURE this can also be implemented for example as rod heating immersed in the melt, which is preferably arranged below the loose-fill bed filter.

During operation of the device according to the invention for filtering and adding grain-refining media to metal melts, especially aluminium melts, as shown in the only FIGURE, a first filtration of the aluminium melt takes place in the first filter chamber 5 with an efficiency between 80 and 95% which is essentially ensured by the bridge formation in the pores of the ceramic foam filter described above. This bridge formation is impeded in the prior art by the. grain-refining material being supplied to the aluminium melt before the first filter. It has been found that in this case no bridge formation takes place inside the pores of the ceramic foam filter. After the first filtration the aluminium melt enters the addition chamber 6 in which a defined amount of grain-refining material is brought into solution. The undesirable undissolved impurities contained in the grain-refining material are then largely removed in a relative small loose-fill bed filter 16 in a second filter chamber 7. As a result in the outlet region there is an aluminium melt with a very small fraction of undissolved impurities which is then cast into high-quality casting products, such as ingots for example.

1. A device for filtering and adding grain-refining materials to metal melts with a first filter (10) and a food for a grain-refining material, whereby the first filter has a porous filter medium, characterised in that the feed for the grain-refining material is arranged in the direction of flow after the first filter (10) and a second filter (16) is arranged in the direction of flow after the feed for the grain-refining material.

2. A device according to claim 1, characterised in that the first filter (10) is constructed as a filter based on cake filtration.

3. A device according to claim 2, characterised in that the first filter (10) has a ceramic foam plate (11).

4. A device according to claim 3, characterised in that the ceramic foam plate (11) has a thickness of 5 to 30 mm, preferably 10 to 15 mm.

5. A device according to one of claims 2 to 4, characterised in that the first filter (10) has at least one element consisting of sintered material.

6. A device according to one of claims 2 to 5, characterised in that the first filter (10) has at least one element consisting of a material deposited by CVD.

7. A device according to one of claims 1 to 6, characterised in that the second filter (16) has a porous filter medium.

8. A device according to claim 7, characterised in that the second filter (36) has a deep-bed filter.

9. A device according to claim 8, characterised in that the deep-bed filter is constructed as a loose-fill bed filter.

10. A device according to one of claims 1 to 9, characterised in that the first filter (10) and/or the second filter (16) can be heated.

11. A method for filtering and adding grain-refining materials to metal melts where the melt is filtered with the aid of a first filter having a porous filter medium and a grain-refining material is added to the melt, especially for implementation using a device according to one of claims 1 to 10, characterised in that the grain-refining material is added to the melt after the first filter and that the melt is filtered after the feed for the grain-refining material in the direction of flow using a second filter.
